(19) United States
(12) Patent Application Publication
(10) Pub. No.: US 2016/0029063 A1
(43) Pub. Date: Jan. 28, 2016

(54) METHOD AND APPARATUS FOR PROVIDING SERVICE OF RANKINGS OF MULTIMEDIA IN SOCIAL NETWORK SERVICE SYSTEM

(71) Applicant: Samsung Electronics Co., Ltd., Suwon-si (KR)

(72) Inventor: June HWANG, Incheon (KR)

(21) Appl. No.: 14/806,081

(22) Filed: Jul. 22, 2015

(30) Foreign Application Priority Data
Jul. 23, 2014 (KR) 10-2014-0093051

(51) Int. Cl. H04N 21/2743; H04N 21/239; H04N 21/482; H04N 21/4223; H04N 21/485; G06F 17/30; H04N 21/4788

(52) U.S. Cl. CPC H04N 21/2743; G06F 17/30345; G06F 17/30876; G06F 17/30781; H04N 21/2393; H04N 21/4788; H04N 21/4223; H04N 21/4854; H04N 21/4828

(57) ABSTRACT

A method and an apparatus for providing a service of rankings of multimedia in a social network service (SNS) system where an SNS server provides uploaded data to a downloader are provided. The method includes extracting added information from data transmitted from an upload electronic device, comparing the extracted, added information with added information of data that was previously received, and detecting the similarity on the added information, creating keywords based on the detected similarity, and creating ranking information by counting the respective keywords in units of a certain period of time, configuring a universal ranking and personal rankings according to respective users' preferences, and providing the ranking information and the universal ranking and the personal rankings.

### CROSS-REFERENCE TO RELATED APPLICATION(S)

This application claims the benefit under 35 U.S.C. §119(a) of a Korean patent application filed on Jul. 23, 2014 in the Korean Intellectual Property Office and assigned Serial number 10-2014-0093051, the entire disclosure of which is hereby incorporated by reference.

### TECHNICAL FIELD

The present disclosure relates to a method and apparatus for providing a service of rankings in a social network service (SNS) system. More particularly, the present disclosure relates to a method and apparatus for providing a service of rankings of multimedia in an SNS system.

### BACKGROUND

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘Beyond 4G Network’ or a ‘Post Long Term Evolution (LTE) System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, Hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

With the rapid development of wireless communication technology, social network services (SNSs) have recently been popularized that may allow people to exchange their ideas and to share information with others over the world wide web anywhere anytime. A system for SNS may be one-user medium or one user community. People may post information on the web using their SNS systems, in real time.

When SNS systems were first released, they were usually used by users to promote friendships, and the like. In recent years, SNS systems have been developed to provide various business models and allow users to share information about various topics with others in real time. For example, SNS allows users to share texts or documents about a particular topic, information about purchase or sale of items, photographs or videos of personal tastes, particular events, accidents, and the like, with others, through a social network.

A variety of information posted on the web through SNS systems may be selected and shared by people. However, in SNS systems of the related art, methods have not been proposed that may allow users to easily search for corresponding information in a form by reflecting the users' tastes or users in a particular local area.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for providing a user's requested information in a social network service (SNS) system.

Another aspect of the present disclosure is to provide a method and apparatus for providing a user's requested information in an SNS system.

Another aspect of the present disclosure is to provide a method and apparatus for providing ranking information about a variety of information in an SNS system.

Another aspect of the present disclosure is to provide a method and apparatus for making mutual communication between an uploader and a downloader in an SNS system.

Another aspect of the present disclosure is to provide a method and apparatus for providing precise ranking information by matching scheduled information in an SNS system.

Another aspect of the present disclosure is to provide a method and apparatus for providing video services, provided in real-time by users, to other users in an SNS system.

In accordance with an aspect of the present disclosure, a method of providing a ranking service of multimedia in an SNS system where an SNS server provides uploaded data to a downloader is provided. The method includes extracting added information from data transmitted from an upload electronic device, comparing the extracted, added information with added information of data that was previously received, detecting the similarity of the added information, creating keywords based on the detected similarity of the added information, creating ranking information by counting the respective keywords in units of a certain period of time, configuring a universal ranking and personal rankings according to respective users' preferences, and providing the ranking information and the universal ranking and the personal rankings.

In accordance with another aspect of the present disclosure, an apparatus for providing a ranking service of multimedia in an SNS system where an SNS server provides uploaded data to a downloader is provided. The apparatus includes an information extracting unit configured to extract added information from data transmitted from an upload electronic device, a similarity comparing unit configured to compare the extracted added information with added information of data that was previously received, and detect the similarity of the added information, a keyword creating unit configured to create keywords based on the detected similarity of the added information, a ranking information providing unit configured to create ranking information by counting the respective keywords in units of a certain period of time, configure a universal ranking and personal rankings according to respective users' preferences, and provide the ranking information and the universal ranking and personal rankings, a network interface configured to make interface for data between upload electronic device and download electronic device through a network, a database configured to store data that is uploading, and a server controller configured to control uploading and downloading of the data, compare for similarity of the added information, and create keywords.

In accordance with another aspect of the present disclosure, a method of uploading multimedia data from an electronic device to a SNS system where the electronic device uploads data to an SNS server is provided. The method comprising running a camera when an uploading is requested, taking a video in response to a user input, and creating content to be uploaded, creating, when a request is made to start uploading data, added information about the content, and providing video content obtained from the camera and added information about the video content to the SNS server.

In accordance with another aspect of the present disclosure, an electronic device for uploading multimedia data to a social network service (SNS) system with an SNS server to which data is uploaded is provided. The electronic device comprising a camera configured to receive light reflected from a subject, and output digital data for still images or videos, a communication unit configured to communicating with the SNS server, a display configured to display the digital data obtained from the camera, a location information creating unit configured to obtain location information about the electronic device, an input unit configured to create and output signals corresponding to a user's inputs, and a controller configured to run the camera when receiving an uploading request from the SNS server, take a video in response to a user input from the input unit, create content to be uploaded, create added information about the content when a request is made to start uploading digital data obtained from the camera, and provide the content obtained from the camera and added information about the content to the SNS server through the communication unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 is a schematic block diagram of a social network service (SNS) system according to an embodiment of the present disclosure;

FIG. 2 is a schematic block diagram of an electronic device according to an embodiment of the present disclosure;

FIG. 3 is a flow diagram that describes a method of uploading data by an upload electronic device according to an embodiment of the present disclosure;

FIG. 4A is a diagram showing a configuration of an initial screen according to an embodiment of the present disclosure;

FIG. 4B is a diagram showing a screen when selecting a category of data to be transmitted to an SNS server according to an embodiment of the present disclosure;

FIG. 4C is a diagram showing a screen when a title input function is activated so that a user may directly input a title according to an embodiment of the present disclosure;

FIG. 4D is a diagram showing a screen showing icons for using global positioning system (GPS), wireless communication, and user's direct input according to an embodiment of the present disclosure;

FIG. 5 is a flow diagram that describes a method of controlling an upload electronic device in a broadcasting mode according to an embodiment of the present disclosure;

FIGS. 6A, 6B, 6C, 6D, and 6E are diagrams showing display states of an upload electronic device when receiving information from a downloader according to various embodiments of the present disclosure;

FIG. 7 is a functional block diagram of an SNS server according to an embodiment of the present disclosure;

FIG. 8 is a signal flow diagram that describes a method of uploading a video from an upload electronic device to an SNS server according to an embodiment of the present disclosure;

FIG. 9 is a flow diagram that describes a method of performing uploading and downloading processes in an SNS server according to an embodiment of the present disclosure;

FIG. 10 is a flow diagram that describes a method for a download electronic device to access an SNS server according to an embodiment of the present disclosure; and

FIGS. 11A, 11B, 11C, and 11D are screens on which an electronic device connected to an SNS server displays data according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

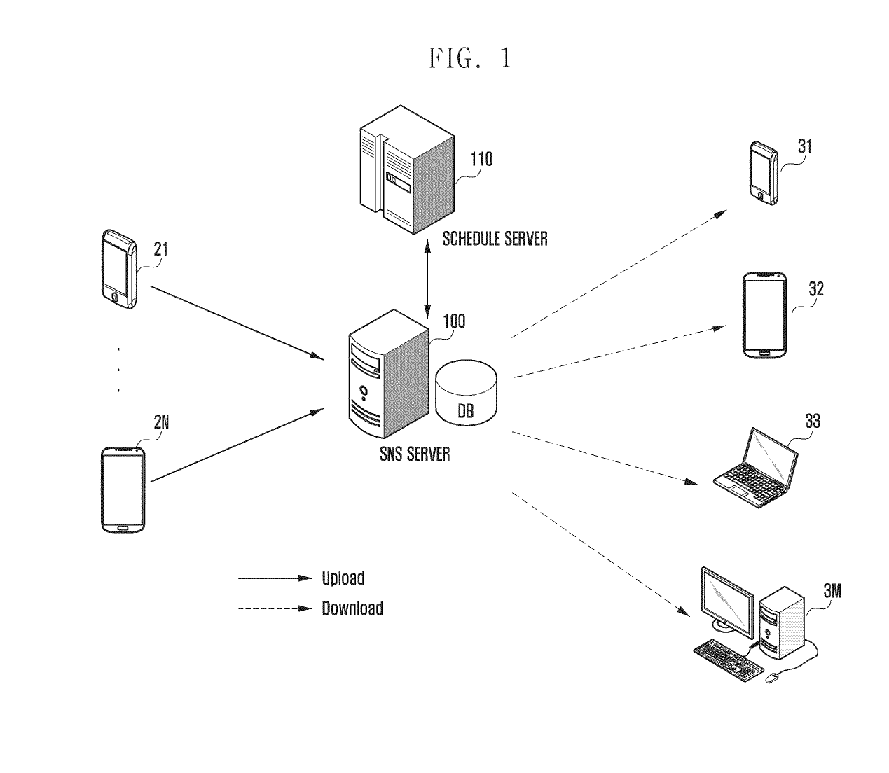

FIG. 1 is a schematic block diagram of a social network service (SNS) system according to an embodiment of the present disclosure.

Referring to FIG. 1, an SNS system includes an SNS server 100, a plurality of upload electronic devices 21, . . . , 2N, and a plurality of download electronic devices 31, 32, 33, . . . , 3M. The plurality of upload electronic devices 21, . . . , 2N, and the plurality of download electronic devices 31, 32, 33, . . . , 3M may communicate with the SNS server 100 through various forms of networks, e.g., Wi-Fi network, a mobile communication network, the Internet, and the like. The SNS server 100 may receive previously scheduled information from a schedule server 110.

The upload electronic devices 21, . . . , 2N may allow users to access the SNS server 100 and to provide information about a particular video to the SNS server 100, and to simultaneously provide location information about the video, title information about the video, and the like to the SNS server 100. The present disclosure will be described based on an example where the user provides a video service to the SNS server 100; however, it should be understood that the present disclosure may also applied to embodiments where information about photographs, and the like is provided to the SNS server 100 in the same or similar method as the example for a video service. Examples of the upload electronic devices 21, . . . , 2N are mobile phones, smartphones, personal computers (PCs), tablet PCs, laptop computers, and the like. The configurations and operations of the upload electronic devices 21, . . . , 2N will be described in detail later referring to the accompanying drawings.

The SNS server 100 creates information about rankings or grades, by issues and regions, of videos transmitted in real-time by upload electronic devices 21, . . . , 2N. The SNS server 100 may provide real-time information to part of the download electronic devices 31, 32, 33, . . . , 3M, based on information, such as location information, taste, preference, and the like, which have registered in the download electronic devices 31, 32, 33, . . . , 3M based on location information contained in real-time video information. The configurations and operations of the SNS server 100 will be described in detail later referring to the accompanying drawings.

The download electronic devices 31, 32, 33, . . . , 3M may obtain real-time information from the SNS server 100 and may provide the obtained information to users. Therefore, a user of a download electronic device may receive video information provided in real-time by a particular upload electronic device, based on the user's location, taste, and the like. In addition, a user of a download electronic device may also request added information with real-time from the SNS server 100. For example, a user of a download electronic device may provide request information, e.g., a request for explanation about a movement or a condition of a camera for a video that the user is currently taking by using the download electronic device, to a corresponding upload electronic device through the SNS server 100. Examples of the download electronic devices 31, 32, 33, . . . , 3M are mobile phones, smartphones, PCs, tablet PCs, laptop computers, and the like. The configurations and operations of the download electronic devices 31, 32, 33, . . . , 3M will be described in detail later referring to the accompanying drawings.

The schedule server 110 may store information about previously scheduled events and provide the information to the SNS server 100. For example, the schedule server 110 may be; servers of press-related companies; a server of an event company holding a particular event; schedule data stored in personal calendars of the SNS server 100; a server of a particular project service company; and the like. It should be understood that the schedule server 110 may be implemented with any type of systems if the systems may provide previously scheduled information to the SNS server 100.

As shown in FIG. 1, for the sake of convenience, it will be appreciated that network configurations between the SNS server 100 and the upload electronic devices 21, . . . , 2N and between the SNS server 100 and the download electronic devices 31, 32, 33, . . . , 3M are omitted.

Referring to FIG. 1, the present disclosure may be divided into three systems. A first system is related to upload electronic devices and the operations. A second system is related to SNS servers and the operations. A third system is related to download electronic devices and the operations.

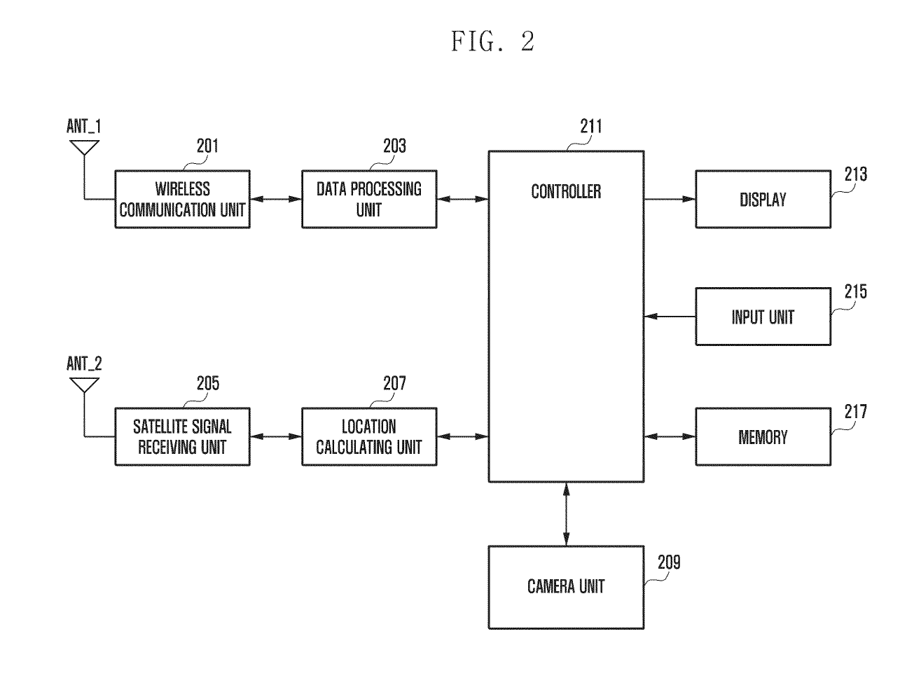

FIG. 2 is a schematic block diagram of an electronic device according to an embodiment of the present disclosure.

It should be understood that FIG. 2 shows an electronic device that only includes components required to describe the present disclosure. Therefore, real-electronic devices may further include other types of components as well as those of FIG. 2. In addition, the components shown in FIG. 2 may be included in an upload electronic device and a download electronic device respectively. Therefore, in the following description, the operations of upload electronic device or download electronic device will be described, referring to the components shown in FIG. 2.

Referring to FIG. 2, a first antenna ANT_1 is an antenna that performs transmission/reception of signals between a wireless communication system and an electronic device according to a communication mode. The first antenna ANT_1 may be implemented with one or two antennas.

A wireless communication unit 201 down-converts the frequency of signals received by the first antenna ANT_1 and provides the converted signals to a data processing unit 203. The wireless communication unit 201 up-converts the frequency of data transferred from the data processing unit 203 into the transmission frequency band of the wireless communication system and outputs the converted data to a second antenna ANT_2.

The data processing unit 203 may demodulate and decode data received by the wireless communication unit 201 and may detect the signal strength, and the like. The data processing unit 203 provides the demodulated and decoded data to a controller 211. The data processing unit 203 encodes and modulates data transferred from the controller 211 and transfers the processed data to the wireless communication unit 201.

A second antenna ANT_2 is an antenna for receiving satellite signals, e.g., global positioning system (GPS) signals. A satellite signal receiving unit 205 receives signals from a plurality of satellites through the second antenna ANT_2, down-converts the frequency of signals and provides the converted signals to a location calculating unit 207. The location calculating unit 207 calculates the current location of the electronic device by using the signals transmitted from a plurality of satellites and outputs the calculated current location to the controller 211.

The electronic device may be implemented without including the second antenna ANT_2, satellite signal receiving unit 205, and location calculating unit 207. In that case, the location of the electronic device may be calculated by using triangulated information between base stations of wireless communication systems and an electronic device or by using location information registered in a Wi-Fi system.

A camera unit 209 may include a lens, an image obtaining module (not shown) for converting light reflected from a subject into digital signals, and the like. The camera unit 209 may take still images or photographs or create information about videos under the control of the controller 211, and may provide the still image or video information to the controller 211.

The controller 211 may control the entire operation of the electronic device. In particular, when the electronic device serves as an upload electronic device according to the present disclosure, the controller 211 may perform a control operation for the electronic device to provide information about taken videos to the SNS server 100. In addition, when the electronic device serves as a download electronic device according to the present disclosure, the controller 211 may control the display of information provided by the SNS server 100 and also control the operation of providing requested particular information to an upload electronic device. The entire operation of the controller 211 will be described in detail later referring to the accompanying drawings.

A display 213 may display states of the electronic device, and the like, under the control of the controller 211. The display 213 may also display information obtained by the camera unit 209, e.g., photographs or videos. The display 213 may display information transmitted from the SNS server 100 under the control of the controller 211. The display 213 may be implemented with a liquid crystal display (LCD), light emitting diodes (LEDs), and the like. It should be understood that the present disclosure is not limited to types of the display 213.

An input unit 215 may be implemented in the form of a combination of: keying, touching, hovering, and speech recognition, and the like. When the input unit 215 is implemented with keys, the input unit 215 creates an input signal corresponding to a user's pressed key and provides the created signal to the controller 211. When the input unit 215 is implemented with a touch or a hover detection module (not shown), the input unit 215 creates an input signal corresponding to a user's touch or hover and provides the created signal to the controller 211. When the input unit 215 is implemented with a microphone (not shown) for recognizing speech, the input unit 215 may extract speech information from the microphone and may directly provide the extracted speech information to the controller 211 so that the controller 211 may recognize the speech. Alternatively, the input unit 215 may include an additional module for recognizing speech.

A memory 217 may be implemented with a read only memory (ROM), a random access memory (RAM), a hard disk drive, and the like. The memory 217 may include internal type of memory and external type of memory. The memory 217 may include a storage area for storing data that the controller 211 uses to perform control operations and a storage area for temporarily storing data created when the controller 211 performs control operations. The memory 217 may further include a storage area for storing a user's requested data, e.g., address book, schedule information, photograph data, video data, and the like.

### 1. Operation as Upload Electronic Device

When an event occurs that a user of an upload electronic device, or an uploader, has wanted to take an image by using his/her electronic device, the uploader may run an upload application installed on the electronic device. For example, when an uploader happens to witness a traffic situation in the vicinity of a traffic accident site or to see a guerrilla gig by a star performer or when an uploader watches a football match in a stadium, the uploader may upload the information to the SNS server. The method of uploading the information is described as follows referring to the accompanying drawings.

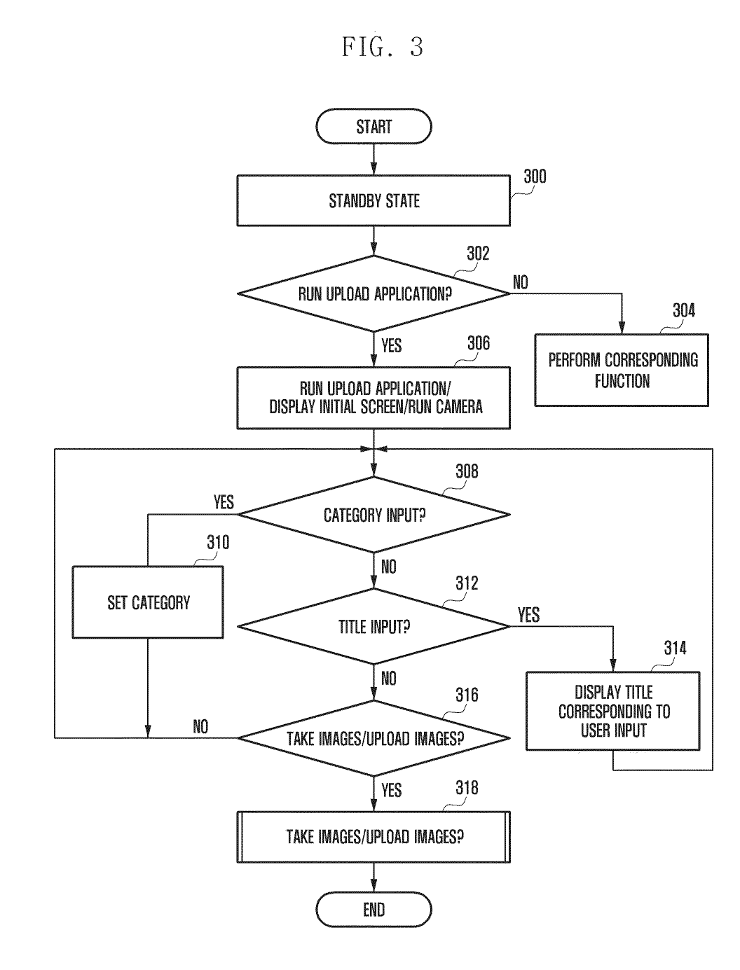

FIG. 3 is a flow diagram that describes a method of uploading data by an upload electronic device according to an embodiment of the present disclosure.

Referring to FIG. 3, the controller 211 of the upload electronic device is in a standby state at operation 300. Examples of the standby state are a state waiting for a particular event from a user, e.g., a request for running a particular application, or a state waiting for the reception of data from a wireless communication network. When a particular event occurs, the controller 211 determines whether an upload application has run at operation 302. When the controller 211 ascertains that an upload application has not been run, or other applications have run, in operation 302, the controller 211 performs a function corresponding to the application at operation 304. On the contrary, when the controller 211 ascertains that an upload application has been run in operation 302, the controller 211 proceeds with operation 306. An example of a case that an upload application is run may be a state where the uploader discovers information item that he/she wants to take images of, e.g., a particular accident or an event, and the like. Another example of a case that an upload application is run may be a condition where the uploader wants to directly make movements, e.g., playing an instrument, singing a song, dancing, and the like.

Referring back to operation 302, when the controller 211 ascertains that an upload application has been run, the controller 211 reads an upload application from the memory 217, runs the upload application, creates data for the initial screen, and controls the display 213 to display the screen data in operation 306. The controller 211 also controls the camera unit 209 to be in a live preview mode in operation 306. The live preview mode may be a state where information about a video is obtained through the camera unit 209 and displayed on the screen of the display 213.

The controller 211 may set the running of the camera unit 209 through another process, instead of operation 306. For example, the controller 211 may control the display 213 to display the initial screen. The initial screen may be a screen showing items, such as category, title inputting, location inputting, camera running, and the like. In that case, the camera unit 209 may be run according to a camera running request.

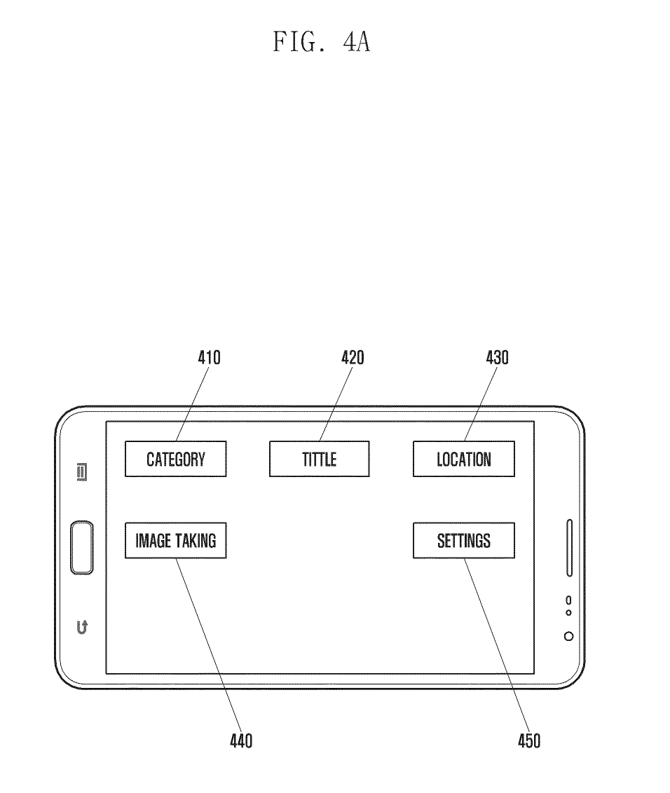

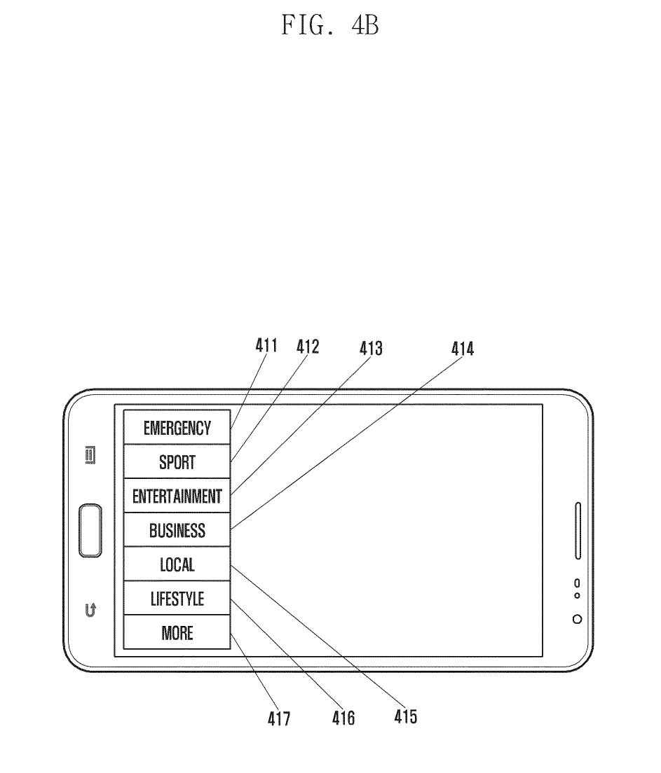

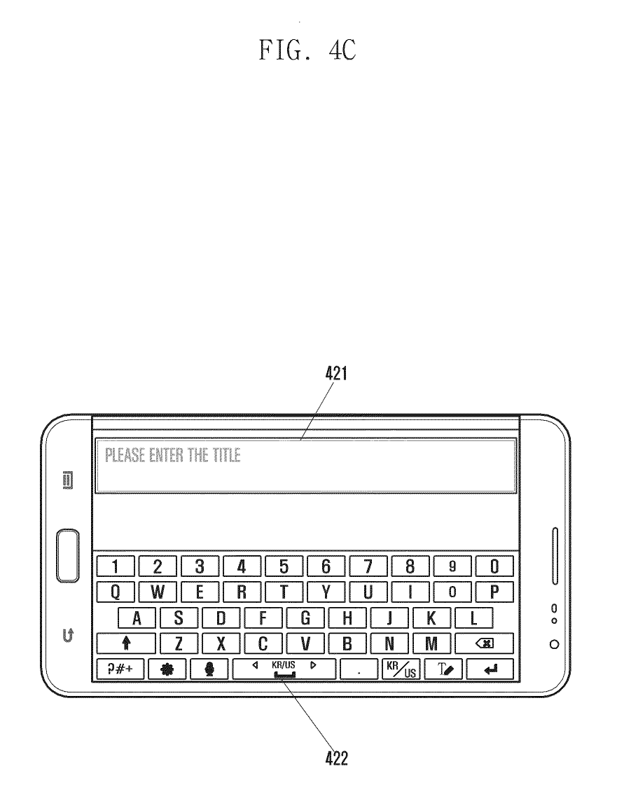

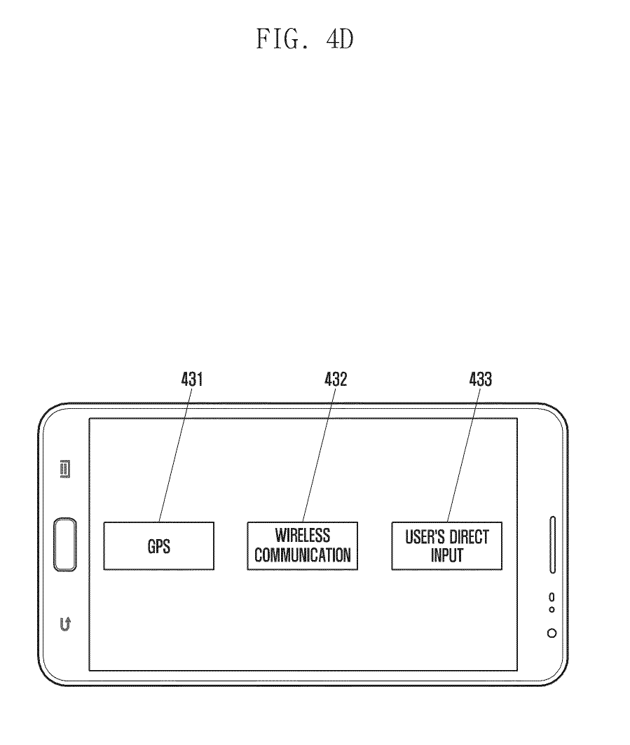

In a state that the initial screen is displayed on the display 213, the controller 211 may detect information input through the input unit 215 and determine the function to be performed according to the detection. This is described, based on the initial screen, referring to FIG. 4A.

FIG. 4A is a diagram showing a configuration of an initial screen according to an embodiment of the present disclosure.

Referring to FIG. 4A, an initial screen may be a background screen of which state is altered according to whether the camera unit 209 is run as described above. For example, when the camera unit 209 is running as in operation 306, the information obtained by the camera unit 209 is displayed as a background screen on the display 213. On the contrary, when the camera unit 209 is separately running, a preset form of screen, e.g., an image provided by an application, a particular color screen, and the like, is displayed as a background screen on the display 213.

Referring to FIG. 4A, the initial screen shows a plurality of icons 410, 420, 430, 440 and 450. The initial screen may be implemented to show more icons than those shown in FIG. 4A or part of those shown in FIG. 4A. The initial screen, shown in FIG. 4A, displays a category icon 410, tittle inputting icon 420, location inputting icon 430, image taking icon 440 and settings icon 450.

The controller 211 detects whether one of the icons on the screen is selected. For example, the controller 211 may determine whether a category icon 410 is selected in operation 308. The controller 211 may determine whether a title inputting icon 420 is selected in operation 312. The controller 211 may determine whether an image taking icon 440 is selected in operation 316. The controller 211 may also determine whether a location inputting icon 430 or settings icon 450 is selected.

When the controller 211 ascertains that a request is made to select a category icon 410 or to input a category in operation 308, the controller 211 controls the display 213 to display a preset list of categories as shown in FIG. 4B.

FIG. 4B is a diagram showing a screen when selecting a category of data to be transmitted to an SNS server according to an embodiment of the present disclosure.

Referring to FIG. 4B, the controller 211 controls the display 213 to display preset categories according to the selection of category icon in operation 310. For example, the controller 211 may control the display 213 to display icons of categories: emergency icon 411, sport icon 412, entertainment icon 413, business icon 414, local icon 415, lifestyle icon 416 and more icon 417. The display 213 may show a background screen according to a time point that the camera unit 209 is run, e.g., information obtained by the camera unit 209. The display 213 may also show a preset screen provided by an application, as background screen. When the controller 211 detects an input signal for selecting one of the category icons, 411, 412, 413, 414, 415, 416, and 417 through the input unit 215, the controller 211 sets the category corresponding to the input signal. After that, the controller 211 may return the display 213 to a state that the display 213 shows the screen of FIG. 4A.

When the controller 211 ascertains that a title inputting icon 420 is selected in operation 312, the controller 211 controls the display 213 to display a title inputting screen and a title corresponding to a user's entered information to the input unit 215, as shown in FIG. 4C, in operation 314. Inputting a title may be implemented in such a way that a user directly input a title right before uploading data, a user's speech for a title is recognized, or a title is automatically input through a particular computer vision, and the like, when meeting a preset condition.

FIG. 4C is a diagram showing a screen when a title input function is activated so that the user may directly input a title according to an embodiment of the present disclosure.

Referring to FIG. 4C, the title inputting screen may be configured to include a keyboard area 422 with keys corresponding to numbers, letters, signs, and the like, and a title display area 421 for displaying information input through the keyboard area 422. An uploader may enter letters by touching or hovering above the keys of the keyboard area 422. After the input has been completed through the keyboard 422, the controller 211 controls the display 213 to return to a state that the controller 211 displays the initial screen.

FIG. 4D is a diagram showing a screen showing icons for using global positioning system (GPS), wireless communication, and user's direct input according to an embodiment of the present disclosure.

Referring to FIG. 4D, although it is not shown in FIG. 3, the cases where a location inputting icon (not shown) and settings icon (not shown) are selected and the corresponding processes are performed are similar to the method of inputting a category and a title described above. For example, when a location inputting icon is selected, a location may be input by using a module 431 for receiving GPS signals installed to the electronic device (the satellite signal receiving unit 205 and the location calculating unit 207 shown in FIG. 2); by making a request from a wireless communication system 432 by controlling a wireless communication module (the wireless communication unit 201 and data processing unit 203 shown in FIG. 2); or by using a user's direct input 433, as shown in FIG. 4D. When a settings icon is selected, the settings may be previously configured to set up: the initial setting of a location inputting mode, the setup of a background screen, a default setup of a category, a basic setup of a title, and the like.

When the controller 211 ascertains that an image taking icon 440 is selected or a request is made to start taking an image in operation 316, the controller 211 obtains video information through the camera unit 209 and transmits the obtained video information to the SNS server 100 in operation 318. When the location inputting has been set up, the location information may be contained in the metadata of the obtained video information and may be transmitted to the SNS server 100, along with a preset category and title.

In the foregoing description referring to FIG. 3, category, title, and the like, input to the electronic device, may be information to combine with a user's preference information in the SNS server 100, which will be described later. When an uploader obtains information about a particular issue and performs transmission of the obtained information through the upload electronic device, the configuration may be set up to further include added information items in the obtained information so that mapping may be performed according to his/her preference.

The SNS server 100 may extract added information items from the uploaded information and may combine the event information with a user's preference information, thereby ranking hot issues by individuals. For example, when a person likes a football player, e.g., C. Ronaldo, and his/her preference is recorded in a user preference of SNS, the ranking of an event, which might have been 102 according to an event extracting method of the related art, may be 6 as the event is combined with the preference. The user preference may also be defined based on category as well as a player's name. Examples of the user preference are a category, such as ‘Sport,’ a word, ‘International football,’ and the like. An extraction of user preference may be obtained by gathering statistics on social networking activities about an issue with a high frequency, from among users' various activities on SNS platforms. For example, social networking activities, such as frequently visiting posting webpages of friends related to international football, expressing ‘like’ or ‘dislike,’ replying with comments, and the like, are used to obtain statistics. The statistics by content items may be used.

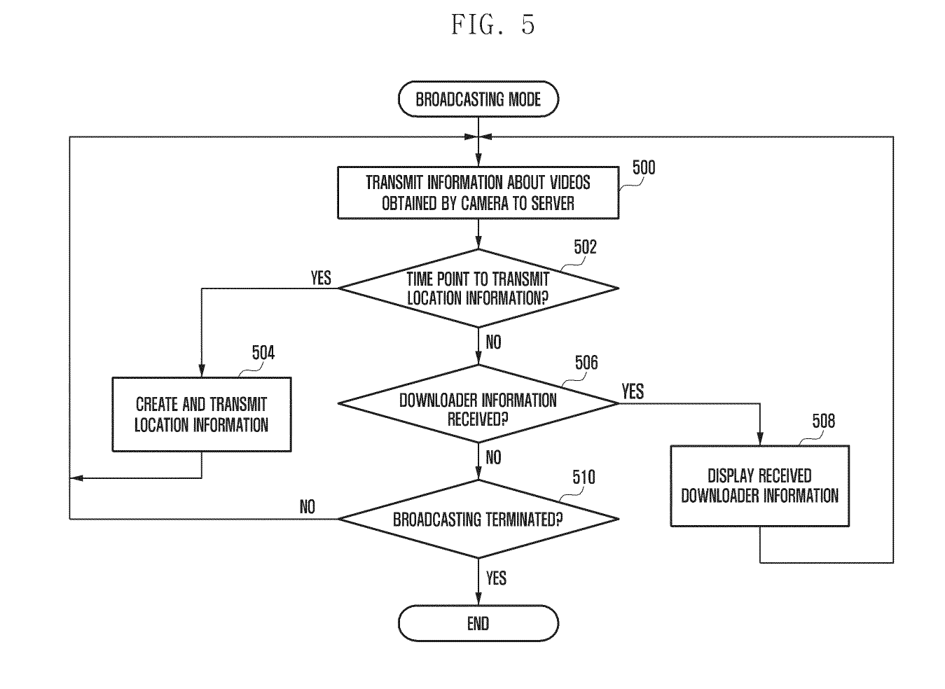

FIG. 5 is a flow diagram that describes a method of controlling an upload electronic device in a broadcasting mode according to an embodiment of the present disclosure.

Referring to FIG. 5, the controller 211 of the upload electronic device processes information obtained from the camera unit 209 in a form of information to be transmitted to the SNS server 100, and controls the data processing unit 203 and the wireless communication unit 201 to transmit the information about the taken video to the SNS server 100 through a wireless communication network in operation 500. The form of video to be transmitted to the SNS server 100 may be a streaming form.

When the controller 211 of the upload electronic device transmits a first video, the controller 211 may transmit category information, title, location information, time information, and the like, which is set, along with the video. If a category and title have not set through the method shown in FIG. 3, the controller 211 may transmit their default values. For example, the default value of category may be one of the following: ‘emergency,’ ‘etc.,’ and a user's set value. The default value of title may be one of the following: ‘untitled,’‘personal video,’ and a user's set value. In an embodiment of the present disclosure, the title information and category information may be changed by the user while taking images.

The location information may be information about a relative or absolute location used in a GPS service, a location based service (LBS), and the like. The time information means information from a time point that a current video streaming starts to a current time point/time that the streaming is in process.

The issue category previously set through the method shown in FIG. 3 may be added, as a prefix, to the title of a video, and may be transmitted to the SNS server 100. When the video is classified to a hot issue, the category may be used as an input value. When a video is uploaded without any category, the video may be automatically assigned to emergency.

While the controller 211 transmits the information obtained from the camera unit 209, the controller 211 determines whether a time to transmit location information has come in operation 502. A description about whether a time to transmit location information has come was not provided while explaining the method of FIGS. 3 and 4 and this is because the user may set through the settings icon in such a way that location information is transmitted in units of a preset period of time. For example, when a user takes images while moving by train or car or while walking or running, the location information varies. Therefore, the controller 211 may determine whether a time to transmit location information has come in operation 502.

When the controller 211 ascertains that a time to transmit location information has come in operation 502, the controller 211 controls the satellite signal receiving unit 205 and the location calculation unit 207 to obtain information about the current location and to transmit the obtained information or to transmit, after adding the obtained information into metadata of the information obtained from the camera unit 209, the metadata in operation 504. After that, the controller 211 returns to operation 500.

On the contrary, when the controller 211 ascertains that a time to transmit location information has not come in operation 502, the controller 211 determines whether to receive particular information from a downloader in operation 506. Examples of the particular information from a downloader are letter information, information for requesting a particular activity, speech information, and the like. This operation may be performed by upload electronic devices with a full-duplex communication function. Therefore, the operation may be omitted for upload electronic devices with a half-duplex communication function.

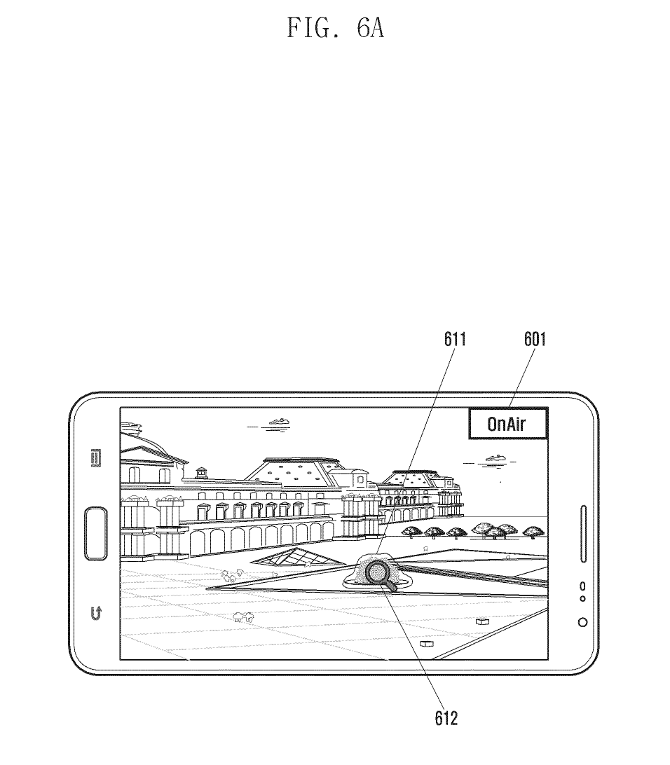

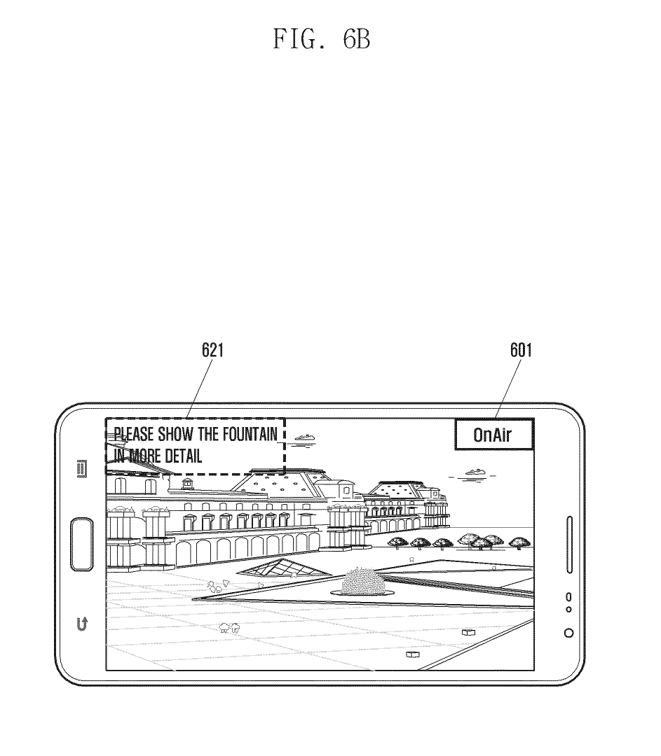

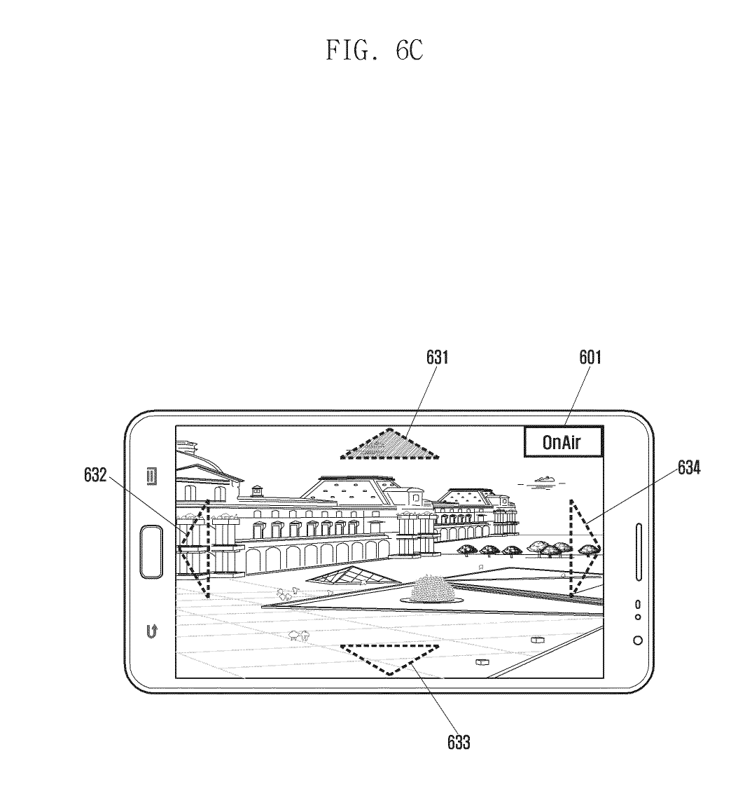

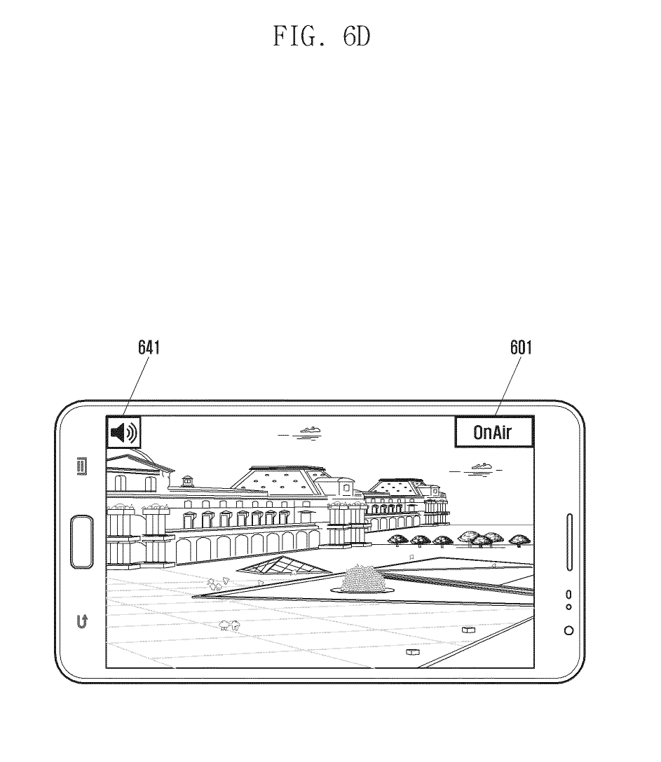

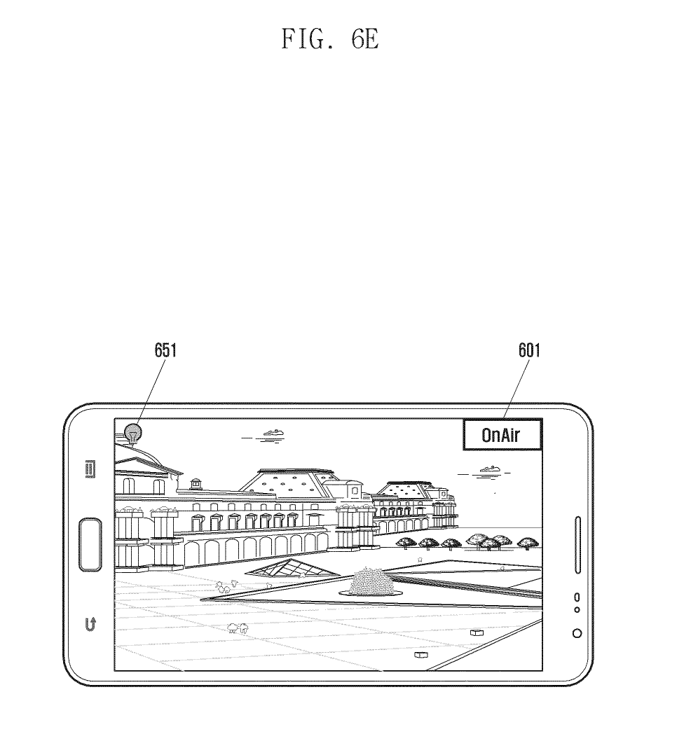

When the controller 211 ascertains that downloader information is not received through the wireless communication unit 201, the controller 211 ascertains whether broadcasting is terminated in operation 510. If the broadcasting is terminated, the controller 211 ends processing. Otherwise, the process continues to operation 500. When the controller 211 ascertains that downloader information is received through the wireless communication unit 201 and the data processing unit 203 in operation 506, the controller 211 may display the received downloader information on the display 213 in operation 508. This process is described in detail as follows referring to FIGS. 6A to 6E.

FIGS. 6A to 6E are diagrams showing display states of an upload electronic device when receiving information from a downloader according to various embodiments of the present disclosure.

Referring to FIG. 6A, since the upload electronic device is in a process of taking a video and transmitting the video to the SNS server 100, the process may show an icon 601 indicating the current state, on air, on the screen. During on air, when the upload electronic device receives, from a particular download electronic device, information that selects a particular object 611 and wants to view the selected object 611 in detail, the controller 211 may display a zoom icon 612 for enlarging the object 611 on the display 213.

Referring to FIG. 6B, since the upload electronic device is in a process of taking a video and transmitting the video to the SNS server 100, the upload electronic device may show an icon 601 indicating the current state, on air, on the screen. During on air, when the upload electronic device receives a text message from a particular download electronic device, the controller 211 may control the display 213 to set a window for showing the received text message and to display the message on the window 621. The text message displaying window 621, such as a chat window, may be processed in such a way that the background color is transparent or a particular color set by the user. In addition, the controller 211 may control the display 213 to show text in a user's preset color.

Referring to FIG. 6C, since the upload electronic device is in a process of taking a video and transmitting the video to the SNS server 100, the upload electronic device may show an icon 601 indicating the current state, on air, on the screen. During on air, the upload electronic device receives a request for moving the camera with varying angles from a particular download electronic device. When the upload electronic device receives a request for moving the camera to a specific direction from a particular download electronic device, the controller 211 may control the display 213 to show upward, leftward, downward and rightward moving request icons 631, 632, 633 and 634 and to show, when a request is made to move the camera to a direction, e.g., upward, the upward moving request icon 631 in a identifying mode, such as by coloring the upward moving request icon 631in a particular color or by blinking the upward moving request icon 631, and the like. Although the embodiment of FIG. 4C shows four icons to request the movement of the camera in the up, down, left, and right directions, it should be understood that the display 213 may be modified to further show four icons to request the movement of the camera in the top-left, top-right, bottom-left and bottom-right directions.

Referring to FIG. 6D, since the upload electronic device is in a process of taking a video and transmitting the video to the SNS server 100, the upload electronic device may show an icon 601 indicating the current state, on air, on the screen. During on air, the upload electronic device detects a request for controlling the volume from a particular download electronic device. When the upload electronic device receives a request for controlling the volume, the controller 211 may display a volume control icon 641 on the display 213. When the uploader selects the volume control icon 641, the controller 211 may display both the current volume value and a volume value requested by the downloader. In that case, the uploader may keep the current volume value or may alter the current volume value to the volume value requested by the downloader or any other value. Therefore, the controller 211 receives the uploader's input information through the input unit 215 and alters the current volume to the corresponding input volume.

Referring to FIG. 6E, since the upload electronic device is in a process of taking a video and transmitting the video to the SNS server 100, the upload electronic device may show an icon 601 indicating the current state, on air, on the screen. During on air, the upload electronic device detects a request for controlling illuminance, contrast, white balance, and the like from a particular download electronic device. When the upload electronic device receives a request for controlling brightness, contrast, white balance, and the like from a particular download electronic device, the upload electronic device may display a light control icon 651 on the display 213. When the uploader selects the light control icon 651, the controller 211 may display one or more of the following: current brightness, current contrast, and current white balance. The controller 211 may display the current brightness, current contrast, and current white balance, along with the corresponding values requested by the downloader, respectively. In that case, the uploader may keep the current corresponding values or may alter the current corresponding values to the values requested by the downloader or any other values. Therefore, the controller 211 receives the uploader's input information through the input unit 215 and alters one or more of the following: current brightness, current contrast, and current white balance to the corresponding input values.

In addition to the information described above, a download electronic device may transmit speech information to an upload electronic device. For example, a download electronic device may directly request information from an upload electronic device by transmitting speech information to the upload electronic device through a service, voice over Internet protocol (VoIP), and the like. In that case, the controller 211 of the upload electronic device demodulates and decodes a speech signal from the download electronic device and outputs audible signals through the speaker (shown in FIG. 2). That is, the upload electronic device may provide a service that enables the uploader to make conversation with one or more downloaders.

As such, the processes are performed in operation 508 shown in FIG. 5. While performing the operation 508, the operation 500 continues to be performed. In addition, in operation 508, a process for a user to alter category, title, and the like, may be additionally performed. Since this process may be performed in a way similar to the method of displaying the received downloader information, its detailed description is omitted.

### 2. Operation as SNS Server

The SNS server 100 may provide data transmitted from an upload electronic device to a variety of downloaders in real-time, and also information about rankings of videos uploaded according to preferences of downloaders to the downloaders. The ranking information may alter according to personal preference, regions, time, and the like. For example, the SNS server 100 may extract information about a particular event by using added information (title of a video, region information, time, and the like) transmitted from the upload electronic device. The SNS server 100 receives, from a downloader, messages or data that the downloader transmitted to an uploader, and transmits the messages or data to the uploader, thereby enhancing the quality of a real-time service. The configuration and operation of the SNS server 100 are described in detail as follows referring to the accompanying drawings.

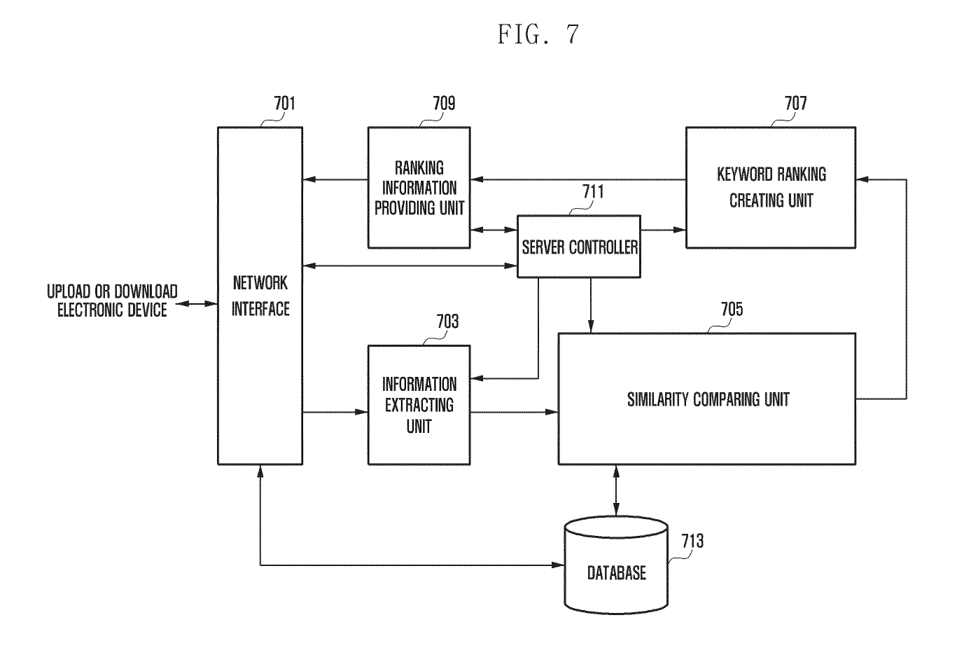

FIG. 7 is a functional block diagram of an SNS server according to an embodiment of the present disclosure.

Referring to FIG. 7, a network interface 701 receives data from upload electronic devices 21, . . . , 2N, and transmits data to download electronic devices 31, 32, 33, . . . , 3M, over the Internet, a wireless network, and the like. The network interface 701 processes data to transmitted or received data, through networks.

An information extracting unit 703 extracts added data from the data transmitted from upload electronic devices, under the control of a server controller 711. For example, the information extracting unit 703 may extract an identifier of the upload electronic device, the location information, time information, title information, category information, and the like, which are transmitted by the upload electronic device, along with or separately from video information, under the control of the server controller 711.

The information extracting unit 703 provides the extracted information to a similarity comparing unit 705. The similarity comparing unit 705 may include an area for storing added information items, e.g., a time-spatial filter (not shown), provided from the information extracting unit 703. The similarity comparing unit 705 may compare the similarities of added information items. For example, the similarity comparing unit 705 may detect a similarity between the titles of uploaded, different videos, and/or a similarity between the regions and/or times, may count the value of detected similarities, may create a particular keyword and the counted value of similarity on the keyword, and may provide the created results to the keyword ranking creating unit 707.

A keyword ranking creating unit 707 may create a universal ranking and a personal ranking, based on the information transferred from the similarity comparing unit 705, under the control of the server controller 711. The universal ranking may be created based on only the frequencies of videos uploaded for a preset period of time. From among the universal rankings, the personal ranking is created in such a way that information items are prioritized according to whether they accord with personal tastes preset by individuals or with weights. The keyword ranking creating unit 707 provides the created ranking information to the ranking information providing unit 709.

The ranking information providing unit 709 may convert data into a form of information to provide same or different ranking information by respective users, and may provide the converted information to corresponding users through the network interface 701. As an example, when a particular user requests to receive ranking information in the form of push message, the ranking information providing unit 709 may create universal ranking information and personal ranking information according to the user's preference, in units of a preset period of time or in a case that a particular event exists, and may transmit the created rank information to the user. As another example, when a setting is made so that a particular user may receive, when he/she connects to the SNS server 100, universal ranking information and personal ranking information according to the user's preference, the ranking information providing unit 709 may provide the universal ranking information and personal ranking information only when the user connects to the SNS server 100. As still another example, for a user whose information related to personal ranking information has not stored, e.g., a user who makes a first connection, the ranking information providing unit 709 may provide only universal ranking information to the user.

A database 713 may receive and store information about videos, transferred from the network interface 701, and added information corresponding to the video information, under the control of the server controller 711. The database 713 may receive streaming data, covert, when video streaming data has been broadcast, the streamed data into video on demand (VoD) data, and store the VoD data, under the control of the server controller 711. The database 713 may buffer video data in real-time and provide the buffered data to a download electronic device, under the control of the server controller 711.

The server controller 711 may control the reception and storage of information about videos and the added information, uploaded by an upload electronic device; the comparison of similarities on the received information, the creation of keywords, the provision of keyword ranking information, and the like. The server controller 711 may control the database 713 to store received video data, and also to store, after converting the received video data into VoD data, the converted VoD data. While the server controller 711 receives video data from an upload electronic device and provide the video data to one or more download electronic devices, when the server controller 711 receives, from a download electronic device, letters or information that the download electronic device has requested from an upload electronic device, the server controller 711 may transmit the requested letters or information to the upload electronic device.

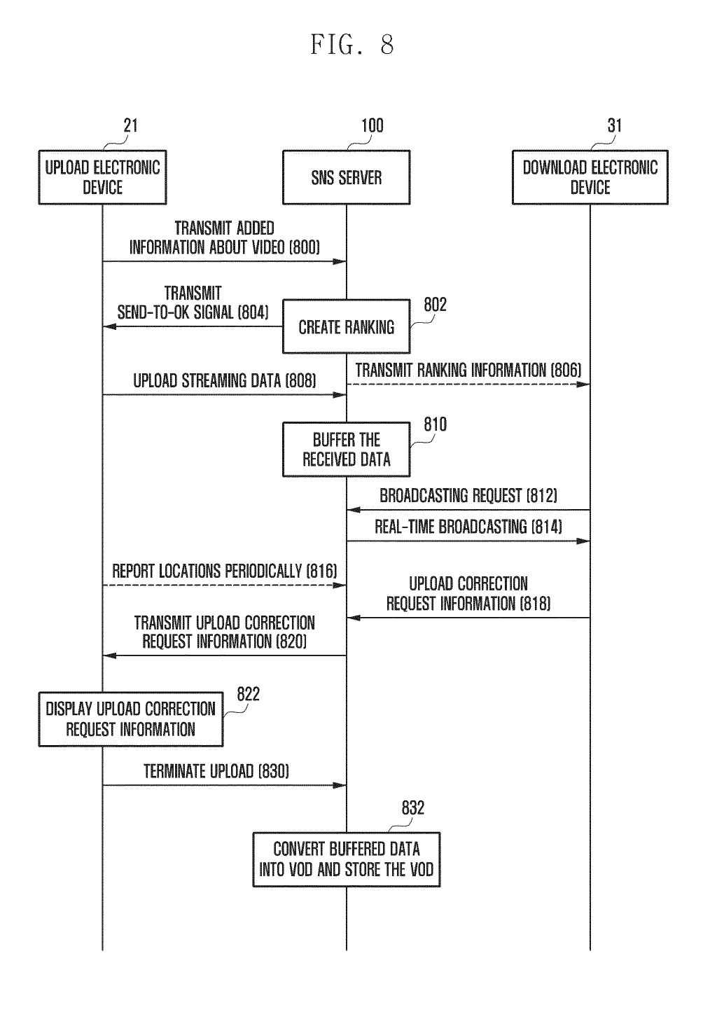

FIG. 8 is a signal flow diagram that describes a method of uploading a video from an upload electronic device to an SNS server according to an embodiment of the present disclosure.

In order to explain the embodiment of FIG. 8, it may be assumed that there are one or more upload electronic devices and one or more download electronic devices that receive video data from the corresponding upload electronic devices. For example, data that an upload electronic device has transmitted to the SNS server 100 may be received by no electronic device or one or more download electronic devices. There may be one or more upload electronic devices according to regions or in the same region. However, for the sake of convenience, the embodiment shown in FIG. 8 is described as including one upload electronic device 21 and one download electronic device 31.

For the sake of convenience, a detailed description about the connection and authentication between the upload electronic device 21 and the SNS server 100 will be omitted below. A detailed description about the connection and authentication between the download electronic device 31 and the SNS server 100 will also be omitted below.

Referring to FIG. 8, the upload electronic device 21 transmits added information about a video to be uploaded to the SNS server 100 in operation 800. Examples of the added information about a video to be uploaded are a user's identification (ID), location information (GPS and camera orientation information), time information, title information, category information, and the like. As an example, when the file format of a video data to be transmitted is incomplete, the location information may be contained in metadata of the video data. As another example, when a video data has a format that cannot create metadata in a state where the video file is not created, the location information may be transmitted along with other information before transmitting a streaming file. Therefore, the SNS server 100 may detect a time point that the streaming information is uploaded by using the added information.

The SNS server 100 may create ranking information from the received, added information about a video through the method described above referring to FIG. 7, in operation 802. The ranking information may be divided into a universal ranking and a personal ranking.

The SNS server 100 may transmit a signal for allowing for transmission, Send-to-OK, to the upload electronic device 21 in operation 804. After creating a ranking in operation 802, the SNS server 100 may transmit the ranking information to the download electronic device 31 through a push message in operation 806. The transmitted ranking information may be universal ranking information that is equally provided to all users and personal ranking information that is differently set according to individuals' tastes and preferences.

When the upload electronic device 21 receives the transmission allowing signal, Send-to-OK, in operation 804, the upload electronic device 21 may transmit the taken video streaming information to the SNS server 100 in operation 808.

The SNS server 100 may buffer the received streaming data in the database 713 in operation 810. The buffered data may be converted to a form of data, such as VoD data, and stored in the server.

During the process of buffering the received data in operation 810, when the SNS server 100 receives information about a broadcasting request from the download electronic device 31 in operation 812, the SNS server 100 may transmit the video data to the download electronic device 31, in real-time, in operation 814. The ‘real-time’ refers to a case that the SNS server 100 transmits the information from the upload electronic device 21 to the download electronic device 31 immediately after the download electronic device 31 receives the information from the upload electronic device 21. It should be understood that the embodiment does not consider: delay times by a delay of the SNS server 100 to perform a data matching, a network delay from the upload electronic device 21 to the SNS server 100, and a network delay from the SNS server 100 to the download electronic device 31. In operation 814, the real-time broadcasting service may last until the download electronic device 31 stops the downloading process or the upload electronic device 21 completes an uploading process.

When the location continues to vary, the upload electronic device 21 may periodically transmit the varied location information to the SNS server 100 as in operation 816. In that case, the SNS server 100 may continue to track and record the location information about the video and may reflect the tracked location information to the calculation for rankings of keywords.

The SNS server 100 receives, from the download electronic device 31, information about a request that the download electronic device 31 makes from the upload electronic device 21, e.g., a request for correcting an uploaded video, a request for enlarging a particular letter, a particular object, and the like, a request for controlling the volume, a request for moving the camera to vary in angle for taking images, a request for correcting brightness, and the like, in operation 818. The SNS server 100 transmits the received request information to the upload electronic device 21 in operation 820.

The upload electronic device 21 may display the received, upload correction requesting information in operation 822. Since the method of displaying the upload correction request information was described above referring to FIGS. 6A to 6E, it is not explained in the following description.

When the upload electronic device 21 has completely uploaded the video information to the SNS server 100, the upload electronic device 21 may transmit an upload termination message to the SNS server 100 in operation 830. After receiving the upload termination message, the SNS server 100 may convert the buffered data into VoD data and store the VoD data in the database 713 in operation 832.

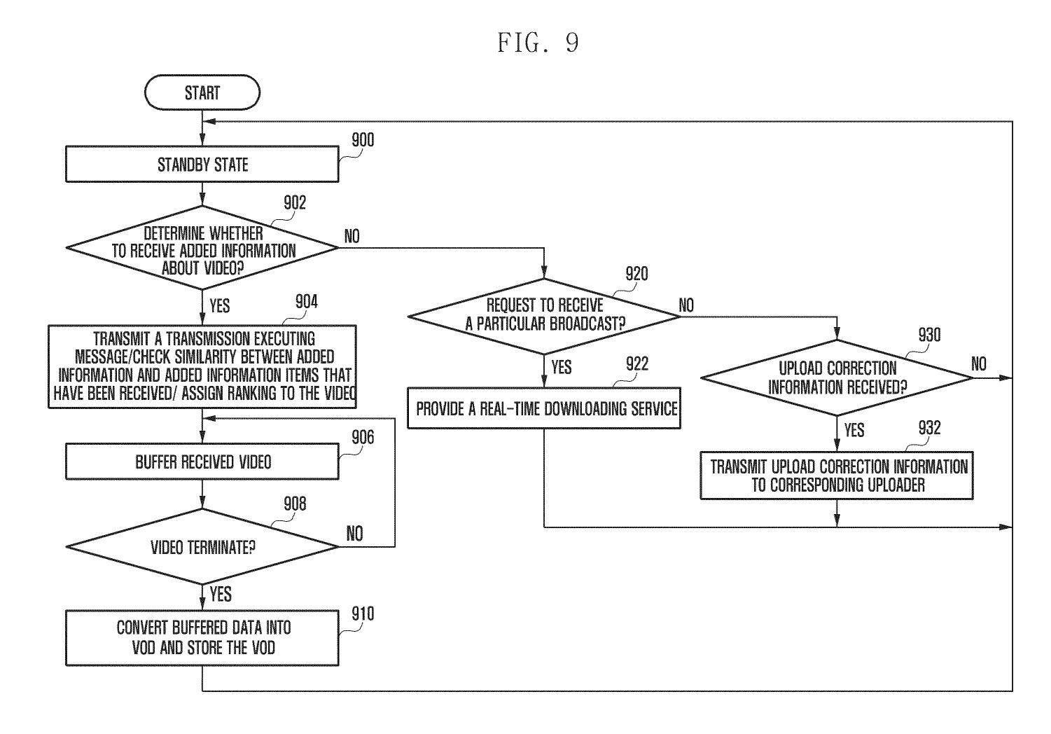

FIG. 9 is a flow diagram that describes a method of performing uploading and downloading processes in an SNS server according to an embodiment of the present disclosure.

Referring to FIG. 9, the server controller 711 is in a standby state in operation 900. The standby state may be a state where the server controller 711 waits for a particular event or a state where the server controller 711 receives video data from one or more upload electronic devices. The standby state may be a state where the server controller 711 provides a service to a particular download electronic device. The standby state may be a state where the server controller 711 determines whether to receive a new request from a particular electronic device, e.g., an upload electronic device or download electronic device.

While the server controller 711 is in a standby state, the server controller 711 determines whether to receive added information about a video from a particular upload electronic device in operation 902. When the server controller 711 receives added information about a video from a particular upload electronic device in operation 902, the server controller 711 proceeds with operation 904. When the server controller 711 does not receive added information about a video from a particular upload electronic device in operation 902, the server controller 711 proceeds with operation 920.

More specifically, when the server controller 711 receives added information about a video from a particular upload electronic device in operation 902, the server controller 711 creates a transmission executing message for allowing the upload electronic device to perform transmission and transmit the message to the upload electronic device in operation 904. The server controller 711 may also check the similarity between the added information and added information items that have been received and may assign a ranking to the video in operation 904.

The similarity checking process and the ranking assigning process are described in detail as follows. The server controller 711 may compare added information about a video uploaded from an upload electronic device and added information items from other upload electronic devices with other information items stored (buffered) in the current database 713, and may assign a detailed event name. For example, it is assumed that an upload electronic device of user ID ‘121222’ transmits, to a upload location ‘234.12,123.22,’ information such as time ‘on Dec. 25, 2014 at 13:45,’ title ‘Appearance of Girl group 2NE1,’ and category ‘entertainment.’ In that case, the server controller 711 may extract the information through the information extracting unit 703. The server controller 711 may control the similarity comparing unit 705 to make a similarity, based on the received information, in a natural language processing. The natural language processing is an operation to remove sentence elements without keywords, such as postpositions, exclamations, conjunctions, and the like. When information about the vicinity of XX Store near Gangnamyeok Station in Seoul is detected as corresponding coordinates on the map, the server controller 711 may add the information to the title. That is, the server controller 711 may create a new title as ‘Appearance of Girl group 2NE1, in front of XX Store near Gangnamyeok Station.’

After that, the server controller 711 searches videos that are currently uploaded again or videos that have been loading for the videos of the same or similar coordinates by using the extracted event by the similarity comparing unit 705 and detects the video of similarity. When margin values of X and Y information in GPS signals exists, the server controller 711 determines a video to be searched based on the margin values during the search and detection process for the video. For example, when a margin is 4, the server controller 711 searches all videos uploaded from a regain defined as a rectangle by coordinates (230.12, 119.22) and coordinates (238.12, 127.22). The margin values may be values empirically accumulated while managing servers. The margin values may be values of distances within which a camera may recognize objects and that are applied to a map as coordinates.

The server controller 711 may control the similarity comparing unit 705 to search for a video of which the upload start time is within a range of margin value, based on a start time of taking the video that is uploading, considering the time similarity of events as well as the margin value of location information. When the threshold of the start time is 1 hour, videos from among the videos uploaded from a region within the boundary are selected that they have been taken since Dec. 25, 2014, 12:45 pm. As described above, the server controller 711 may control the similarity comparing unit 705 to determine whether the videos filtered based on the thresholds, location and time, have the same event.

Respective videos that are uploading contain event names extracted from location/time information and titles. For example, the uploaded video contains an event name, e.g., ‘Appearance of Girl group 2NE1, in front of XX Store near Gangnamyeok Station.’ The same event name may be detected by analogizing the correlation between words contained in the titles of the filtered videos, respectively. For this process, an event name needs an essential element, i.e., one unified information item corresponding to an ‘object to be taken’ and a ‘place.’ For example, since information such as ‘what to do’ corresponds to ‘added information,’ the information does not serve as the essential element. When essential elements are extracted from the uploaded video, ‘Appearance of Girl group 2NE1, in front of XX Store near Gangnamyeok Station,’ they are ‘Girl group 2NE1,’ and ‘front of XX, Gangnamyeok Station.’ It is assumed that other filtered videos have titles as examples, as follows, respectively.
a) ‘Girl group, 2NE1 beautiful’
b) ‘Girl group, see CL a member of 2NE1 at Angelinus’
c) ‘Girl group, directly take image of 2NE1’
d) ‘Girl group, see 2NE1 on Tuesday’
e) ‘Exploration for shoes in ABC mart’

The server controller 711 controls the similarity comparing unit 705 to process the titles in a natural language processing and with refinement of region information, thereby creating the processed titles as follows.
a′) ‘Girl group, 2NE1 ‘front of XX, Gangnamyeok Station’
b′) ‘Girl group, see CL a member of 2NE1 in front of Angelinus, Gangnamyeok Station’
c′) ‘Girl group, directly take image of 2NE1 in front of XX, Gangnamyeok Station’
d′) ‘Girl group, see 2NE1 in front of XX Gangnamyeok Station on Tuesday’
e′) ‘Shoes in ABC mart Gangnamyeok Station’

Information corresponding to [who (what)] and [where] may be extracted from the titles and listed as follows.
a) [Girl group, 2NE1], [front of XX, Gangnamyeok Station]
b) [Girl group, see CL a member of 2NE1], [front of Angelinus Gangnamyeok Station]
c) [Girl group, 2NE1], [front of XX Gangnamyeok Station]
d) [Girl group, see 2NE1], [front of XX, Gangnamyeok Station]
e) [Shoes], [ABC mart Gangnamyeok Station]

The information items corresponding to [object] and [where] may be additionally refined by, for example, a voting, based on the information items describe above. A server includes a hierarchy database for essential items by using a data mining or existing keyword-based search engine. By using this, a higher level of word is selected when conflict occurs during the voting. For example, referring to the example described above, [object] are [2NE1] in item a), [CL] in item b), [2NE1] in item c), [2NE1] in item d), and [shoes] in item e). With respect to the word relation, word ‘2NE1’ contains ‘CL,’ but is not correlated with word ‘shoes.’ Therefore, items a), b), c), and d) have the same [object], i.e., [2NE1]. However, item e) has [object], i.e., [shoes], which is not the same event, and thus excluded from the same event object.

The [where] is processed in the same way described above. [front of XX Gangnamyeok Station] in item a), [front of Angelinus Gangnamyeok Station] in item b), [front of XX Gangnamyeok Station] in item c), [front of XX Gangnamyeok Station] in item d), and [ABC mart Gangnamyeok Station] in item e) are shortened to [Gangnamyeok Station] as the upper concept of the items a), b), c), d), and e).

Therefore, the videos satisfying both the two types of essential elements are items a), b), c), and d), and the event name is extracted as ‘2NE1 Gangnamyeok Station.’

The process of extracting location information may be a process to extract not a place name on the map but GPS coordinates. In that case, a corresponding boundary may be a virtual location based on a range of threshold for a region on the map, instead of a hierarchy structure. That is, in the foregoing example described above, since the margin is 4 based on (234.12, 123.22), the area from (230.12, 119.22) to (238.12, 127.22) is in the same region. In that case, when [object] is the same, the object is regarded as the same event.

The above mentioned process is described, based on one of the methods for determination that searches for an upper concept from a hierarchy based on the location information without condition. However, it should be understood that the selection may be made according to decision by majority using a large amount of information or a weight-based selection algorithm may be used. For example, the absolute majority has mentioned not ‘2NE1’ but ‘CL,’ the essential element [object] of the determined event name is ‘CL.’ The essential element may be selected by applying different weights to ‘2NE1’ and ‘CL.’ The re-configuration of the title may be performed, with corresponding probabilities, according to the level of similarity on region information or time information.

During the process described above, the electronic device may transmit the electronic device's orientation information, obtained by the gyroscope sensor, and the like, to the server, when performing an uploading process. When the information is transmitted to the server, the server may detect locations of subjects of which the images are taken by the upload electronic device, by using: location information and time information about videos; and orientation information about the upload electronic devices that have taken the videos, uploaded to the database. When the detected locations of subjects are the same, the title may be re-configured with a relatively high reliability.

The server controller 711 may count the number of same events that are currently uploaded and create the rankings, by using information about events extracted by the keyword ranking creating unit 707. In the embodiment of the present disclosure described above, the counted number of videos created as events, [2NE1] and [Gangnamyeok Station], are taken may be calculated from information videos received in operation 902+four videos (a, b, c, and d) that have been uploaded.

Most of the information items may be videos based on events that have been previously scheduled. For a scheduled event, information related to schedules may have been stored in a server related to a particular individual's calendar and subjects of notification of events and variety of presses, or may be provided to the SNS server 100. This may be the information provided by the schedule server 110 described above referring to FIG. 1. Therefore, the server controller 711 may precisely set whether the information is a scheduled video based on the information provided by the schedule server 110.

For example, the server may compare information that has been obtained from the schedule server 110 and information about a particular video transmitted from an upload electronic device with time and location information about the server, may determine the similarity based on the comparison, and may check whether a corresponding video is a scheduled event. When the SNS server 100 has not previously obtained information from the schedule server 110, the SNS server 100 may: transmit, to the schedule server 110 that will receive a particular video, queries for a personal schedule, an event schedule and a press, which have been previously defined based on time and location information about the video; take information about an event that is planned to occur close to the time/place; and match the event information.

The information from the schedule server 110 may be the name of an event that is planned to occur at a particular region or time, participants in the event, brief information about the event, and the like. When the server controller 711 of the SNS server 100 ascertains that a region/time information item contained in the added information transmitted from an upload electronic device and a scheduled region/time information item are within a particular threshold range, the server controller 711 may detect the event similarity through an event at which a video of an upload electronic device is scheduled to be taken, thereby detecting the event.

Through the operation described above, the keyword ranking creating unit 707 may set, when a plurality of upload electronic devices exist with respect to the same event, the universal ranking to be relatively high. The personal ranking may be set so the weights are applied to the universal ranking, considering personal taste, and the like or only a particular category is extracted.

The keyword ranking creating unit 707 may adjust rankings by counting the number of download electronic devices as well as the number of upload electronic devices. The weights applied to the number of upload electronic devices and the number of download electronic devices may be adjusted to differ from each other.

As described above, rankings of particular events may be created in the information extracting unit 703, similarity comparing unit 705 and keyword ranking creating unit 707.

Referring back to FIG. 9, after transmitting a transmission executing message to the upload electronic device, the server controller 711 may receive video data from the upload electronic device and may buffer the received video data in the database in operation 906. The buffered information may be provided, in real time, to other download electronic devices. The server controller 711 determines whether to receive a message notifying of the video uploading termination from the upload electronic device in operation 908. When the server controller 711 ascertains that uploading the video is terminated in 908, the server controller 711 converts the buffered data into VoD data and stores the VoD data in the database 713 in operation 910.

On the contrary, when the server controller 711 does not receive added information about a video from a particular upload electronic device in operation 902, the server controller 711 determines whether a request is made to receive a particular broadcast file, e.g., a video file that the upload electronic device is currently uploading, in operation 920. When the server controller 711 ascertains that a request has been made to receive a corresponding video file in operation 920, the server controller 711 controls the network interface 701 and the database 713 to provide the broadcast file that is currently buffered to the electronic device that has requested for the reception of the file in operation 922.

On the contrary, when the server controller 711 ascertains that a request has not been made to receive a video file that the upload electronic device is currently uploading in operation 920, the server controller 711 determines whether to receive a video correction requesting message from a particular download electronic device in operation 930. When the server controller 711 receives a video correction requesting message from a particular download electronic device in operation 930, the server controller 711 transmits the received video correction requesting message to the corresponding upload electronic device in operation 932. This process may make a real-time communication between the upload electronic device and the download electronic device.

### 3. Operation as Download Electronic Device

Basically, download electronic devices may be viewers' electronic devices. That is, users of download electronic devices: select particular video data that upload electronic device are uploading in real-time; determine whether there is video information that they want to watch or have interest in from the video data; receive a corresponding video; and watch the video. To do this, it is important how the download electronic devices select a particular one of the videos that is currently uploading. In the following description, a method of selecting video data according to the preset period of time is described in detail.

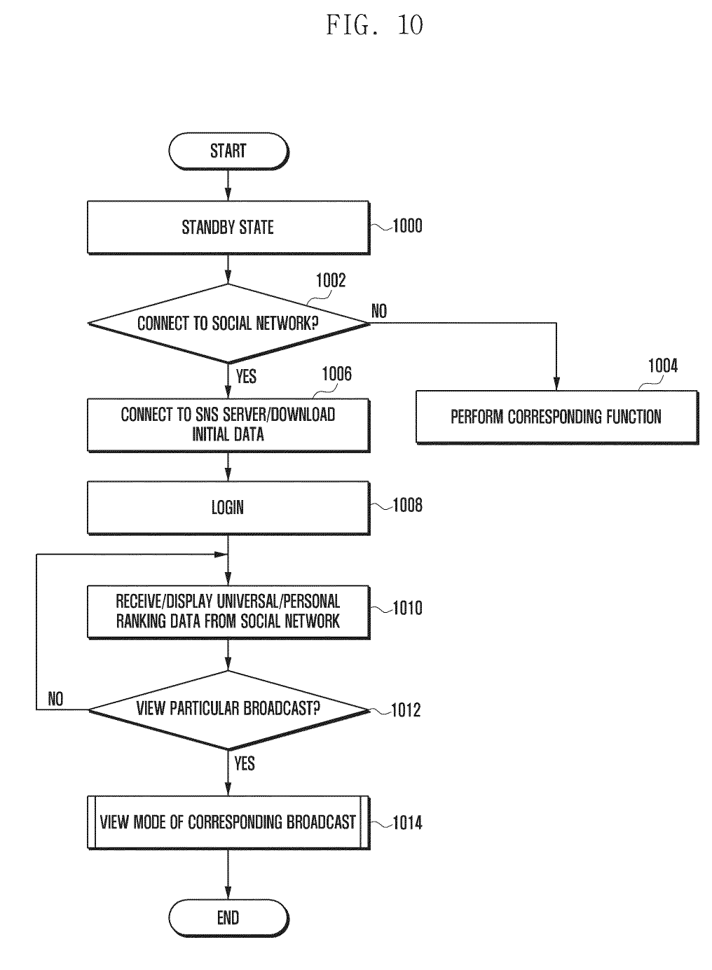

FIG. 10 is a flow diagram that describes a method for a download electronic device to access an SNS server according to an embodiment of the present disclosure.

The embodiment of the present disclosure shown in FIG. 10 is described based on the electronic device referring to FIG. 2. It should be understood that the electronic device shown in FIG. 2 may further include various components, and may comprise PCs, tablet computers, smart televisions (TVs), and the like, which may perform the operations in the flow diagram shown in FIG. 10.

Referring to FIG. 10, the controller 211 of the download electronic device is in a standby state in operation 1000. Examples of the standby state are a state waiting for a particular event from a user, e.g., a request for running a particular application, or a state waiting for the reception of data from a network. When a particular event occurred, the controller 211 determines whether a request for connecting to a social network is made through the input unit 215 in operation 1002.

When the controller 211 ascertains that a request for connecting to a social network has not been made through the input unit 215 in operation 1002, the controller 211 may perform a function corresponding to an event that occurred in operation 1004. For example, the controller 211 controls the wireless communication unit 201 and the data processing unit 203 to connect to the SNS server 100 over a wireless communication network in operation 1004. The procedures of connecting through a wireless communication network and to the SNS server 100, and the like may be performed by well-known technologies or wireless communication connecting methods that will be developed in the future. When the electronic device connects to the SNS server 100, the controller 211 may transmits, to the SNS server 100, the location information about the electronic device calculated by the satellite signal receiving unit 205 and the location calculating unit 207.

On the contrary, when the controller 211 ascertains that a request for connecting to a social network has been made through the input unit 215 in operation 1002, the controller 211 may connect to the SNS server 100, download initial data from the SNS server 100, and display the initial data on the display 213 in operation 1006. In operation 1008 the controller 211 may initiated a login sequence.

Since the location information about the download electronic device may be transmitted to the SNS server 100, the data displayed on the display 213 may be received, as the initial screen data, based on the location of the download electronic device. This is described in detail as follows referring to the accompanying drawings.

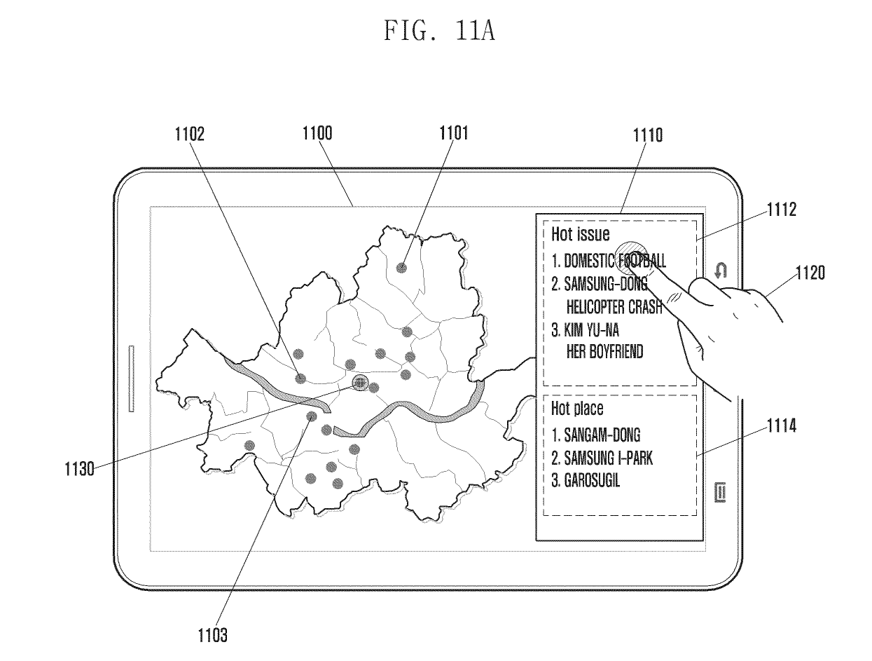

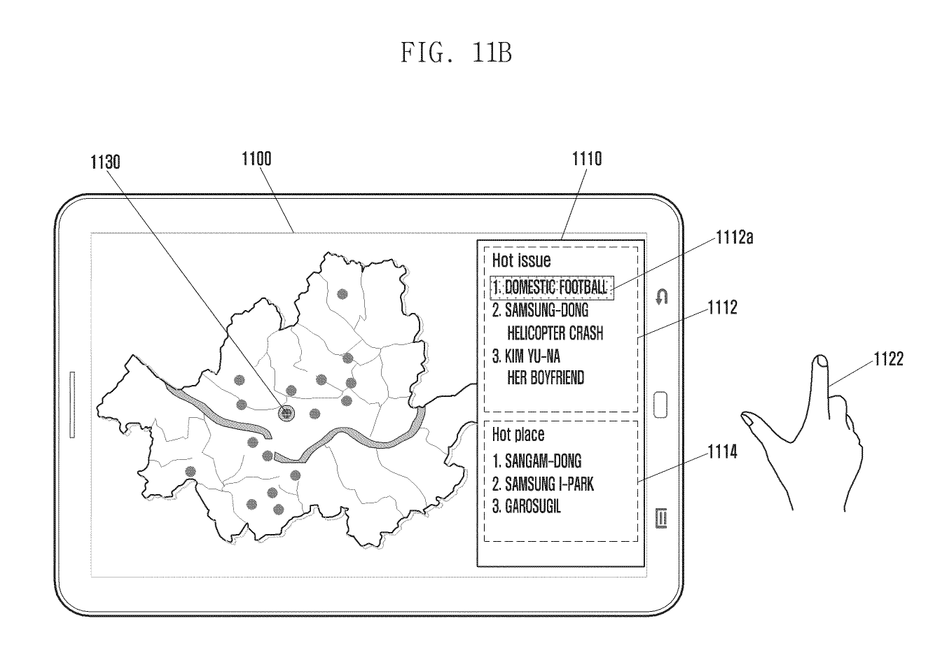

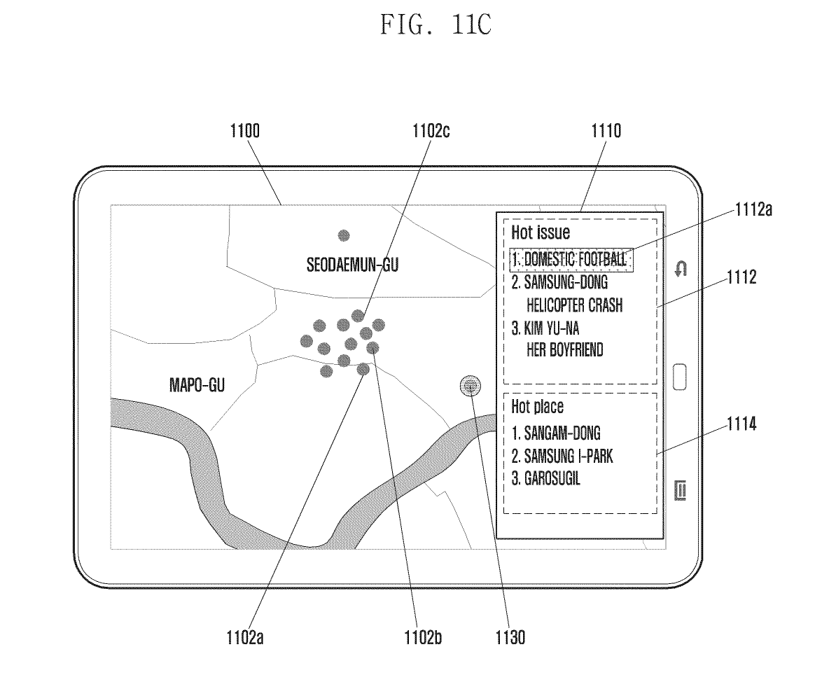

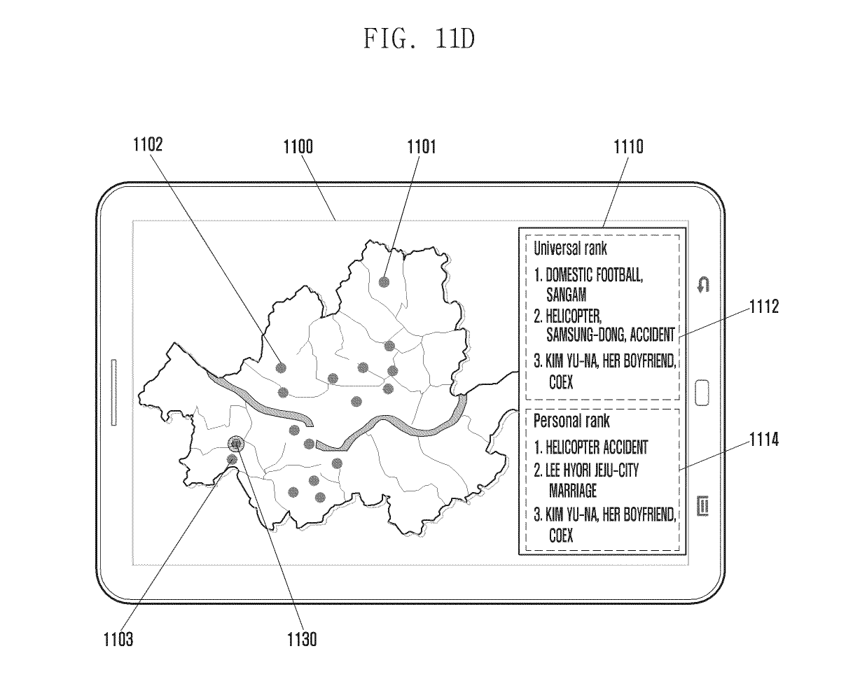

FIGS. 11A to 11D are screens on which an electronic device connected to an SNS server displays data according to an embodiment of the present disclosure.

Referring to FIG. 11A, the screen on the display 213 may be split into a map section 1100 and a text section 1110. The map section 1100 may show a user location-based map with a range, e.g., a map of Seoul, a map of Busan, South Korea, at which a user is located, and the like. As shown in FIG. 11A, the map section 1100 may show a user's location 1130 and places 1101, 1102, 1103, and the like from which videos are uploading. There may be one or more upload electronic devices in the regions corresponding to the places 1101, 1102, 1103, and the like marked on the map section 1100 as from which videos are uploading.

The text section 1110 may be divided into a hot issue subsection 1112 for showing hot issues and a hot place subsection 1114 for showing hot places. The text section 1110 may be configured to display universal ranking information and personal ranking information, based on user's log-in, as described above. The text section 1110 may also alter in form of display according to a user's settings.

When the user selects a particular issue as indicated by reference number 1120 as shown in FIG. 11A, the selected hot issue item may be displayed as shown in FIG. 11B.

Referring to FIG. 11B, a screen showing that one of the hot issue items, i.e., ‘1. Domestic football,’ has been selected is illustrated. As such, when the hot issue item 1112a is selected, the hot issue item 1112a may be displayed as the text letters alter in color, in solid form, or in a combination thereof, thereby showing that the hot issue item 1112a has been selected. In response to the selection of the hot issue, the map section 1100 may show a location where videos corresponding to the hot issue are uploading. When the map section 1100 has already displayed a location where videos corresponding to the hot issue are uploading, the controller 211 may receive the enlargement information about the location and may display the received information on the display 213.

FIG. 11B shows a user's zoom-in or zoom-out action, as indicated by reference number 1122, for enlarging or reducing a particular location on the map section 1100. When a zoom-in or zoom-out action is made on the map section 1100, the corresponding area is displayed to the enlargement or reduction. This is described in detail as follows referring to FIG. 11C.

Referring to FIG. 11C, a screen magnifying the map section 1100 is illustrated. When a particular region is displayed to an enlargement on the map section 1100, details about videos and the uploaders uploading at the corresponding locations may be displayed. For example, when a zoom-in action is applied to a location 1102 shown in FIG. 11A, one of the upload places marked, on the map section 1100, the location 1102 is displayed in detail as a plurality of uploaders 1102a, 1102b, 1102c, and the like, which are distinguishable. In that case, each of the uploaders 1102a, 1102b, 1102c, and the like may also include one or more uploaders. When there are two or more uploaders in the same region, they may be selected on the map section 1100. In that case, the selected uploader may display the details, such as the title, location information and added information, in a form of speech balloon or other display modes, on the map section 1100.

As shown in FIGS. 11A to 11C, when a particular region, e.g., Seoul, Busan, and the like, is displayed to show the entire area, i.e., the entire area of the city, on the map, upload electronic devices at corresponding locations or information about locations where transmission of upload videos are performed may be marked by ‘dots.’ When a zoom-in action is continuously applied to a particular location on the map section 1100, an uploader or a place where uploading is performed, marked by a ‘dot,’ may change in form or size, from the ‘dot’ to ‘icon,’ ‘thumbnail,’ and ‘small video image,’ in order, in the direction of enlargement.

In order to perform the process described above, in response to a map enlargement request, the controller 211 may provide information about a region and a ratio of enlargement, requested for enlargement, to the SNS server 100, receives information from the SNS server 100, and update the map section 1100 based on the received information.

Referring back to operation 1006 shown in FIG. 10, the controller 211 may: connect to the SNS server 100; download initial data from the SNS server 100; display the downloaded data; and request or receive additional data according to a user's action. After that, the controller 211 determines whether the log-in information enters the input unit 215 to request for the logging-in. Logging-in refers to the process to access the SNS server 100. When a request for the logging-in is made, the controller 211 controls the wireless communication unit 201 and the data processing unit 203 to transmit the log-in data to the SNS server 100. Examples of the log-in data are a user's ID and password, and the like.

The controller 211 may receive a corresponding user's authentication information and universal ranking information and personal ranking information, set according to the user's settings, from the SNS server 100 through the wireless communication unit 201 and the data processing unit 203 in 1010. The controller 211 may update the text section 1110 on the display 213 with the universal ranking information and the personal ranking information. FIG. 11D shows a screen on which universal ranking information and personal ranking information is updated after the logging-in.

Referring to FIG. 11D, the map section 1100 may be the same form as in FIGS. 11A and 11B. The map section 1100 shows a user's location 1130 and regions from which at least one video is uploading. The text section 1110 is split into a universal ranking displaying area 1112 and a personal ranking displaying area 1114, and may display personal ranking information that differs from the previous information.

Referring back to FIG. 10, the controller 211 checks whether the user of the download electronic device makes a request to view a particular broadcast through the input unit 215 in operation 1012. When the controller 211 ascertains that the user of the download electronic device has made a request to view a particular broadcast through the input unit 215 in operation 1012, the display 213 enters a view mode for showing the broadcast in operation 1014. In the broadcast viewing mode, the user of the download electronic device may provide the upload electronic device with video control requesting information, such as explanation about operations of the upload electronic device and of the SNS server 100. The video control requesting information may be provided in various forms, such as a real-time text messaging service, a chat service, and the like. While the downloader is viewing an uploader's video through the download electronic device in a broadcast viewing mode, when he/she ascertains that the title and content of the video are matched or the video accords with his/her taste, he/she may estimate the video that is uploading. The estimate may be configured with 1-bit information, such as ‘Like,’ or multi-bit information, and may be transmitted. The estimate data is transmitted to only the SNS server 100, contrary to the video control requesting information. The SNS server 100 may change the rankings based on the estimate data.

According to an embodiment of the present disclosure, uploaders may provide information created at their locations to the social network server in real-time. This system may allow users (SNS viewers) to easily access real-time topics and information about communities in an environment where videos are streamed, widely, at random, in real-time. The system extracts keywords for real-time content to which it is difficult to apply a keyword search, and provides the extracted keywords, as well as previously scheduled events. As such, providing a variety of information through the extraction of keywords may maximize the real-time property between content creators and content consumers and may thus increase the reliability and the pressure of consuming content between content creators and content consumers. In addition, the system may minimize a difference between a time point that content is generated and a time point that the content is consumed.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing a ranking service of multimedia in a social network service (SNS) system where an SNS server provides uploaded data to a downloader, the method comprising:
extracting added information from data transmitted from an upload electronic device;
comparing the extracted added information with added information of data that was previously received;
detecting the similarity of the added information;
creating keywords based on the detected similarity of the added information;
creating ranking information by counting the respective keywords in units of a certain period of time;
configuring a universal ranking and personal rankings according to respective users' preferences, and providing the ranking information and the universal ranking and personal rankings.

2. The method of claim 1, wherein the added information comprises:
a title of the received data and/or location information about the upload electronic device.

3. The method of claim 2, wherein the detecting of the similarity of the added information comprises:
extracting titles from added information items that were previously uploaded, which are within an error range for location information about the upload electronic device; and
extracting information items from the extracted titles, which are consistent with or related to an object.

4. The method of claim 3,
wherein the added information comprises information about an upload start time; and
wherein the titles are extracted from added information items that were uploaded from the upload start time until a certain time.

5. The method of claim 1, further comprising:
receiving, from a download electronic device, a request for the reception of data of a particular video from the data that is uploading; and
providing the video data to the download electronic device in real-time.

6. The method of claim 1, further comprising:
receiving, from a download electronic device receiving video data in real-time, correction requesting information for requesting correction from the upload electronic device; and
transmitting the received correction requesting information to the upload electronic device.

7. The method of claim 1, wherein the universal ranking and the personal rankings are provided to the user when a particular electronic device makes a request for connection.

8. The method of claim 1, wherein the universal ranking and personal rankings are transmitted to respective electronic devices in the form of push messages when a certain time arrives or a particular event occurs.

9. The method of claim 1, further comprising:
converting, when the reception of the upload data is terminated, received data of a video into video on demand (VoD) data, and storing the VoD data.

10. An apparatus for providing a ranking service of multimedia in a social network service (SNS) system where an SNS server provides uploaded data to a downloader, the apparatus comprising:
an information extracting unit configured to extract added information from data transmitted from an upload electronic device;
a similarity comparing unit configured to:
compare the extracted added information with added information of data that was previously received, and
detect the similarity of the added information;
a keyword creating unit configured to create keywords based on the detected similarity;
a ranking information providing unit configured to:
create ranking information by counting the respective keywords in units of a certain period of time,
configure a universal ranking and personal rankings according to respective users' preferences, and
provide the ranking information and the universal ranking and the personal rankings;
a network interface configured to make an interface for data between upload electronic device and download electronic device through a network;
a database configured to store data that is uploading; and
a server controller configured to:
control uploading and downloading of the data,
comparing for similarity of the added information, and
create keywords.

11. The apparatus of claim 10, wherein the added information comprises:
a title of the received data and/or location information about the upload electronic device.

12. The apparatus of claim 11, wherein the similarity comparing unit is further configured to extracts titles from added information items that were previously uploaded, which are within an error range for location information about the upload electronic device, and information items from the extracted titles, which are consistent with or related to an object.

13. The apparatus of claim 12,
wherein the added information comprises information about an upload start time, and
wherein the similarity comparing unit is further configured to extract the titles from added information items that were uploaded from the upload start time until a certain time.

14. The apparatus of claim 10, wherein the server controller is further configured to:
receive, from a download electronic device, a request for the reception of data of a particular video from the data that is uploading; and
provide the video data to the download electronic device in real-time.

15. The apparatus of claim 14, wherein the server controller is further configured to:
receive, from a download electronic device receiving video data in real-time, correction requesting information for requesting correction from the upload electronic device; and
transmit the received correction requesting information to the upload electronic device.

16. The apparatus of claim 10, wherein the server controller is further configured to provide the universal ranking and the personal rankings to the user when a particular electronic device makes a request for connection.

17. The apparatus of claim 10, wherein the server controller is further configured to transmit the universal ranking and the personal rankings to respective electronic devices in the form of push messages when a certain time arrives or a particular event occurs.

18. The apparatus of claim 10, wherein the server controller is further configured to:
convert, when the reception of the upload data is terminated, received data of a video into video on demand (VoD) data, and
store the VoD data in the database.

19. A method of uploading multimedia data from an electronic device to a social network service (SNS) system where the electronic device uploads data to an SNS server, the method comprising:
running a camera when an uploading is requested;
taking a video in response to a user input;
creating content to be uploaded;
creating, when a request is made to start uploading data, added information about the content; and
providing video content obtained from the camera and added information about the video content to the SNS server.

20. The method of claim 19, wherein the content comprises at least one of a category and a title.

21. The method of claim 19, wherein the added information comprises location information about the electronic device and time information that the video content is taken.

22. The method of claim 19, further comprising:
receiving correction requesting information from the SNS server; and
displaying the received correction requesting information on a display.

23. The method of claim 22, wherein the correction requesting information comprises at least one of the following:
request information for enlarging an object to be taken, information about a particular letter;
request information for moving the camera (varying the angle);
request information for controlling the volume; or
request information for controlling the brightness.

24. An electronic device for uploading multimedia data to a social network service (SNS) system with an SNS server to which data is uploaded, the electronic device comprising:
a camera configured to:
receive light reflected from a subject, and
output digital data for still images or videos;
a communication unit configured to communicate with the SNS server;
a display configured to display the digital data obtained from the camera;
a location information creating unit configured to obtain location information about the electronic device;
an input unit configured to create and output signals corresponding to a user's inputs; and
a controller configured to:
run the camera when receiving an uploading request from the SNS server,
take a video in response to a user input from the input unit,
create content to be uploaded,
create added information about the content when a request is made to start uploading digital data obtained from the camera, and
provide the content obtained from the camera and added information about the content to the SNS server through the communication unit.

25. The device of claim 24, wherein the content comprises at least one of a category and a title.

26. The device of claim 24, wherein the added information comprises location information about the electronic device and time information that the video content is taken.

27. The device of claim 24, wherein the controller is further configured to:
receive correction requesting information from the SNS server; and
display the received correction requesting information on the display.

28. The device of claim 27, wherein the correction requesting information comprises at least one of the following:
request information for enlarging an object to be taken,
information about a particular letter,
request information for moving the camera (varying the angle),
request information for controlling the volume, or
request information for controlling the brightness.

28. The device of claim 24, wherein the controller is further configured to:
extract titles from added information items that were previously uploaded, which are within an error range for location information about the upload electronic device, and information items from the extracted titles, which are consistent with or related to an object;
display locations on a map where the extracted titles have been uploaded.
